(19) United States
(12) Patent Application Publication
(10) Pub. No.: US 2019/0216682 A1
(43) Pub. Date: Jul. 18, 2019

(54) Infant Foot Reflexology & Teething Device

(71) Applicant: Laura Michelle Vreeland, Warwick, NY (US)

(72) Inventor: Laura Michelle Vreeland, Warwick, NY (US)

(21) Appl. No.: 15/871,273

(22) Filed: Jan. 15, 2018

(51) Int. Cl. A61H 39/04; A61J 17/02

(52) U.S. Cl. CPC A61H 39/04; A61J 17/02; A61H 2201/10; A61H 2201/1253; A61H 2201/1642; A61H 2201/1695; A61H 2205/125; A61H 2201/165; A61H 2201/1692

(57) ABSTRACT

The invention relates to a novel infant combined foot reflexology and teething method which involves coupling an article of clothing, that is configured to cover a toddler/infant's foot and/or toes and that is made from or comprised of organic, natural or synthetic materials, and a “cap” (teething balls) composed of natural rubber/TPR/Silicone, and which jointly serve as a foot reflexology and teething device, which serve to stimulate the foot reflexology and acupressure points for teething, mouth, head, jaws, etc., and which stimulate homeopathic reflexes that calm the head area, and also provides acupuncture yielding benefits, which includes managing musculoskeletal pain, colic, vomiting, and/or nausea, as well as foot reflexology benefits provided because of the raised bumps on the outside and inside of the rubber toe are, which includes decreased 02 saturation in the blood as well as reduced heart rate, and may also provide security against accidentally biting themselves too hard due to the sock/bootie, “cap” and teething balls, all while staying available to the infant by being securely attached to his/her foot, toes, ankles, feet, and legs, via a securing device such as a velcro strap. These benefits can be achieved by using the invention because not only is the infant stimulated by the raised bumps/teething balls on the outside of the rubber “toe cap” area, but the infant will be stimulating those acupoints and reflexology areas that are associated with increased comfort as noted in this specification.

### CROSS-REFERENCE TO RELATED APPLICATIONS

The application claims the benefit of applicant's prior provisional patent application No. 62/501,143, previously filed on May 4, 2017.

### TECHNICAL FIELD

This disclosure relates to systems and methods for a combined infant foot reflexology & teething device coupled to an article of clothing, of which the following is a specification, reference also being had to the accompanying drawing, forming a part hereof.

### BACKGROUND & FIELD OF THE INVENTION

The invention most closely corresponds with USPTO US Class 606/235, wherein Class 606 relates to surgery and sub-class 235 includes teething devices. The invention relates to a novel infant foot reflexology & teething device wherein the device is comprised of a combined infant foot reflexology and teething device which is coupled to an article of fabric clothing covering an infant's foot (e.g. sock or bootie). The invention helps to stimulate the foot reflexology and acupressure points for teething, mouth, head, jaws, etc., while continuously staying available to the infant by being securely attached to the infant's feet.

Notwithstanding the aforementioned, it should be noted that the invention is not limited in form to the number of different materials that can be utilized to create the invention and/or articles of fabric clothing that can be used simultaneously at any one time and/or the shape of human clothing, as it could take just about any other shape imaginable.

### DESCRIPTION AND CRITICISM OF PRIOR ART

The invention improves upon the prior art, including those referenced in the relevant prior art section noted below. An issue with current teething devices is that all of the prior art till now contain some type of teething device, but either do not contain the ability to stimulate the foot reflexology and acupressure points for teething, mouth, head, jaws, etc., and/or are not continuously available to the infant by being securely attached to him/her.

There is no prior art which combines an infant foot reflexology and teething device and secures the invention to the infant, which are prone to dropping, throwing, and/or removing teething devices coupled to them. Notwithstanding the aforementioned, it should be noted that the invention is not limited in form to the number of different shapes and/or articles of clothing that can be used, as it could take just about any other shape imaginable.

### RELEVANT PRIOR ART INCLUDES

U.S. Pat. No. 9,050,245 Jun. 9, 2015, Beavers.

U.S. Pat. No. 8,920,466 Dec. 30, 2014, Marcus, et. al.

U.S. Pat. No. 8,518,079 Aug. 27, 2013, Sarver.

U.S. Pat. No. 8,475,494 Jul. 2, 2013, Marcus.

### The Invention

### SUMMARY, OBJECTS, ADVANTAGES & REFERENCES

The following is a short summary and does not intend to limit the scope of the invention.

Embodiments described herein relate to a combined infant foot reflexology and teething device that may be coupled to an article of clothing that is configured to cover a toddler/infant's foot that is made from or comprised of organic, natural or synthetic materials.

Embodiments disclosed herein provide systems, methods, materials, fabric and placement for a natural rubber/TPR/Silicone or other combined infant foot reflexology and teething device to be coupled to an article of fabric clothing covering an infant's foot, which will help to stimulate the infant's foot reflexology and acupressure points for teething, mouth, head, jaws, etc. while staying available to the infant by being securely attached to his/her foot, ankles, and legs, via a securing device such as a velcro strap.

As used herein, the terms “cap,” “raised bumps,” “teething balls,” “toe cap,” and any other variation, shall all be used interchangeably to mean the bumps on the natural rubber/TPR/Silicone or other foot caps found on the invention. Furthermore, herein the terms “cap,” “toe cap,” and “teething balls,” “raised bumps,” or any other variation, are intended to cover a non-exclusive inclusion. For example, a method, article, or apparatus that comprises a list of elements is not necessarily limited to only those elements but may include other elements not expressly listed or inherent to such process, article, or apparatus.

When an infant gently bites on his or her toes, it bites on the “toe cap” and the “raised bumps/teething balls” on it, which then stimulates the homeopathic reflexes via the reflexology and acupressure points on the foot thereby serving to calm the head area, and the sock also provides security against accidentally biting themselves too hard.

The invention is a unique product that soothes the teething baby through the application of Complementary and Alternative Medicine (CAM) practices such as: acupuncture, acupressure, and foot reflexology.

According to the Mayo Clinic, “acupuncture is integral to everyday medical practice” (Chop & Lee, 2013, p. 1141). Acupuncture has been used for thousands of years and is rooted in Traditional Chinese Medicine (TCM; Vickers & Zollman, 1999). The use of acupuncture in the United States can be traced back to the 1970s when a journalist for the New York Times documented his positive experience with acupuncture following an appendectomy while visiting China (Reston, 1971). Many populations have experienced positive results from this practice, including infants (Ecevit, Ince, Tarcan, Cabioglu, & Kurt, 2011).

Acupuncture is defined as the stimulation of acupoints which takes place through the insertion of fine needles into the skin (Vickers & Zollman, 1999). According to acupuncture, the human body is fueled by Qi or “vital energy” (Hafner, n.d.) that flows along 12 primary meridians which correspond to various functions or “organs” of the body (Vickers & Zollman, 1999). Acupuncture has been shown to alleviate anxiety and pain (Gentry, McGinn, Kundu, & Lynn, 2012), and has demonstrated effectiveness on children. According to Gentry et al. (2012), acupuncture yields benefits when managing musculoskeletal pain, colic, vomiting, and/or nausea following surgical procedures. Acupuncture has also been shown to help prevent emergence delirium (Gentry et al., 2012).

Indeed, the use of acupuncture on infants is considered to be a form of therapeutic treatment that is beneficial, well tolerated, and generally free of injurious effects (Gentry et al., 2012). Acupuncture can increase bowel movements in children (Landgren, Kvorning, & Hallström, 2010) and help infants who are crying (Landgren et al., 2010). This is because the insertion of an acupuncture needle causes the production of endogenous opioids, which are involved in pain control (Ecevit et al., 2011). Even minimal stimulation of acupoints has been shown to ameliorate symptoms of pain and discomfort (Ecevit et al., 2011). Both acupuncture and acupressure are methods that are used to stimulate acupoints (UCLA Center for East-West Medicine, 2017).

Acupressure is a healing art that has been used for over 2000 years in China (Abbaso\check{g}lu et al., 2015). Acupressure involves the application of pressure to acupoints, which helps alleviate muscle spasms, enhance blood circulation, and calm nerves (Abbaso\check{g}lu et al., 2015).

Furthermore, acupressure is associated with the production of endorphins, norepinephrine, encephalin, and serotonin, all of which inhibit the transmission of pain signals between neurons in the brain (Abbaso\check{g}lu et al., 2015). Acupressure has helped improve visual health behavior among school children and weight gain among premature babies (Abbaso\check{g}lu et al., 2015).

Moreover, acupressure is associated with reduced crying and procedure time when drawing blood from an infant's heel (Abbaso\check{g}lu et al., 2015).

In addition to acupuncture and acupressure, the invention applies the tenets of reflexology. Reflexology is a therapeutic practice that has been used extensively in fields such as midwifery, orthopedics, and neuroscience (Wang et al., 2008). Similar to acupuncture and acupressure, the use of reflexology dates back to ancient Egyptian and Chinese cultures (Wang et al., 2008). Reflexology involves the application of pressure to areas of the feet that are associated with a person's organs or glands (Wang et al., 2008).

In contrast to acupressure, reflexology includes a reflex map of the entire body that is located on the soles of the feet (American Academy of Reflexology, 2017). Among adults, foot reflexology has been shown to assist in asthma control (Dashti et al., 2016). Among infants, reflexology has assisted in reducing pain and increasing relaxation among neonates that were admitted to the NICU (Samadi et al., 2014). According to this study by Samadi et al. (2014), foot reflexology was associated with decreased 02 saturation in the blood as well as reduced heart rate.

According to reflexology, the toes correspond to the head and teeth (Daily Health Post, 2016). The invention employs the tenets of reflexology because the rubber-like area of the sock stimulates the toes, which are associated with the baby's teeth (Chang, n.d.). The invention can provide a holistic solution for teething problems because the raised bumps/teething balls on the outside of the rubber toe area will prompt the baby to use the rubber area as a teething device. As previously stated, there is scientific evidence to support the claims of therapeutic benefits associated with acupuncture, acupressure, and foot reflexology.

These benefits can be achieved by using the invention because not only is the infant stimulated by the raised bumps/teething balls on the outside of the rubber toe cap area, but the infant will be stimulating those acupoints and reflexology areas that are associated with increased comfort as noted above. Furthermore, once the infant chews on the rubber area, all of the toes will be compressed, which will provide additional stimulation to the acupoints and reflexology areas that have been shown to reduce pain.

Finally, The fact that none of the prior art, representing numerous teething devices and other related prior art, have thus far created a product like the invention, proves that the invention is non-obvious. Therefore, the invention is a new, unique, holistic, sustainable, and non-invasive remedy for infant foot reflexology and teething discomfort, which no prior art has achieved thus far.

### REFERENCES

Abbaso\check{g}lu, A., Cabio\check{g}lu, M. T., Tu\check{g}cu, A. U., İnce, D. A., Tekindal, M. A., Ecevit, A., & Tarcan, A. (2015). Acupressure at BL60 and K3 points before heel lancing in preterm infants. Explore: The Journal of Science and Healing, 11, 363-366.
A Chang. (n.d.). Calm fussy babies instantly by massaging these 7 parts of their feet. Retrieved from https://www.littlethings.com/baby-foot-reflexology/
American Academy of Reflexology. (2017). Difference between reflexology and acupressure[Web page]. Retrieved from http://www.americanacademyofreflexology.com/differencebetween-reflexology-and-acupressure/
Chon, T. Y., & Lee, M. C. (2013). Acupuncture. Mayo Clinic Proceedings, 88, 1141-1146.
Daily Health Post. (2016). Press These Points On Your Baby's Feet To Soothe Their Pain For
Better Sleep. Retrieved from https://dailyhealthpost.com/baby-foot-reflexology/
Dashti, S., Shahmari, M., Mirzaaghazadeh, A., & Mirzaaghazadeh, M. (2016). Effect of foot reflexology and olive oil foot massage on asthma control. Global Journal of Health Science, 8(12), 53. Ecevit, A., Ince, D. A., Tarcan, A., Cabioglu, M. T., & Kurt, A. (2011). Acupuncture in preterm babies during minor painful procedures. Journal of Traditional Chinese Medicine, 31, 308-310.
Gentry, K. R., McGinn, K. L., Kundu, A., & Lynn, A. M. (2012). Acupuncture therapy for infants: A preliminary report on reasons for consultation, feasibility, and tolerability. Pediatric Anesthesia, 22(7), 690-695.
Goldfield, E. C., Wolff, P. H. (2002) Motor development in infancy. In: Slater A, Lewis M, editors. Introduction to Infant Development. Oxford: Oxford University Press. p 61-82.
Hafner, C. (n.d.). What is Qi? (and other concepts). Retrieved from https://www.takingcharge.csh.umn.edu/explore-healing-practices/traditional-chinesemedicine/what-qi-and-other-concepts
Landgren, K., Kvorning, N., & Hallström, I. (2010). Acupuncture reduces crying in infants with infantile colic: A randomised, controlled, blind clinical study. Acupuncture in Medicine, 28, 174-179.
Markman, L. (2009). Teething: facts and fiction. Pediatrics in Review, 30(8), e59.
McIntyre, G. T., & McIntyre, G. M. (2002). Teething troubles?. British dental journal, 192(5).
Meer, Z., & Meer, A. (2011). Teething trouble and its management in children. International Journal of Dental Clinics, 3(2).
Reston, J. (1971). Now, about my operation in Peking. New York Times, 1(6).
Samadi, N., Allahyari, I., Mazaheri, E., Rostamnejad, M., Mehrnoush, N., Namadi, M., Naseri, R., & Nahamin, M. (2014). Effect of foot reflexology on physiologic index of neonates. Iranian Journal of Neonatology, 5, 19-22.
UCLA Center for East-West Medicine. (2017). What is the difference between acupuncture and acupressure? [Web page]. Retrieved from https://exploreim.ucla.edu/east-westmedicine/what-is-the-difference-between-acupuncture-and-acupressure/
Vickers, A., & Zollman, C. (1999). ABC of complementary medicine: Acupuncture. BMJ: British Medical Journal, 319 (7215), 973.
Wang, M. Y., Tsai, P. S., Lee, P. H., Chang, W. Y., & Yang, C. M. (2008). The efficacy of reflexology: Systematic review. Journal of Advanced Nursing, 62, 512-520.

### BRIEF DESCRIPTION OF THE DRAWINGS

The drawing accompanying and forming part of this specification is included to depict certain aspects of the invention. A clearer impression of the invention, and of the components and operation of systems provided with the invention, will become more readily apparent by referring to the exemplary, and therefore non-limiting, embodiments illustrated in the drawing. Note that the features illustrated in the drawing are not necessarily drawn to scale.

FIG. 1—is an environmental perspective view illustrating the invention as a sock, and showing its general features, including one embodiment of an infant combined foot reflexology and teething device, showing that the infant combined foot reflexology and teething cap may be configured to be coupled to any outer surface of any article of clothing made to cover a foot with toes by forming a cap covering the toe end or whole foot and of clothing extending partially or completely around toes, or length and width of foot made from natural rubber.

### DRAWINGS—REFERENCE NUMERALS

1—the invention
2—foot reflexology and teething cap
3—sock
4—velcro strip

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description and specification includes what are presently believed to be the best modes of carrying out the invention.

Herein, the terms “comprises,” “comprising,” “includes,” “including,” “has,” “having,” or any other variation, are intended to cover a non-exclusive inclusion. For example, a method, article, or apparatus that comprises a list of elements is not necessarily limited to only those elements but may include other elements not expressly listed or inherent to such process, article, or apparatus.

Further, unless expressly stated to the contrary, “or” refers to an inclusive or and not to an exclusive or. Also, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only.

Those of ordinary skill in the art will appreciate that any term or terms with which these examples or drawings are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” and “in one embodiment.”

Article of clothing may be any type of fabric such as a sock, foot wrap, footie, garment, bootie, slipper, fabric, etc. configured to cover an infant's foot and toes (the article of clothing covering an infant's foot may be referred to herein as a “sock”). Socks are preferably comprised of natural organic materials including, but not inclusive of, cotton, and may be made in a variety of lengths which may extend above or below an ankle or knee or wrist and elbow of an infant.

The invention may be any object designed for an infant to bite, chew, and/or suck on during teething and may made from natural organic materials or synthetic materials or a combination of both. The invention may be comprised of any known materials that are natural or organic such as cotton, natural rubber, etc. The invention may be designed of any shape or size, including but not limited to a toe cover, or full foot cover, etc. The invention may be comprised of various types of textures, such as bumps, ridges, projections, indentations, etc. The invention may also be removably coupled to or permanently coupled to sock.

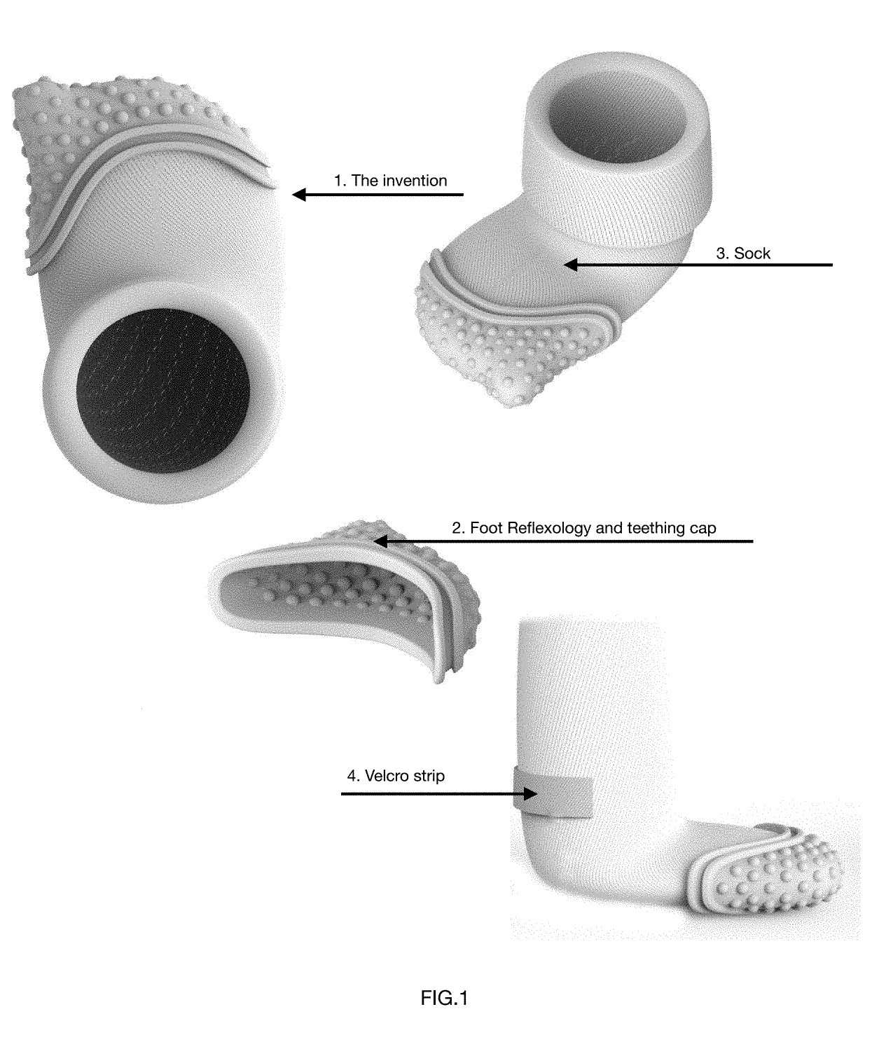

FIG. 1 depicts one embodiment of a teething device. Teething device may include an article of clothing made of organic fabric, natural or synthetic rubber and configured to cover an infant's entire foot and/or toes, and a coupling device such as a velcro strap or some other coupling device.

Socks may be manufactured in a variety of styles such as standard socks or toe socks, where each toe is encased in a respective compartment and out of organic fabric/materials.

The invention may be configured to be coupled to and extend across at least one of an infant's toes, many of, all of the toes on an infant's foot, and/or encompassing or “capping” of the toe end of the sock. The invention may be configured to cover the entire toes or end of the foot in a “cap” style. While an infant's natural instinct is to nibble on fingers and toes, capping the toes with the cap allows for organic teething to be paired with foot acupressure or reflexology benefits.

What is claimed is:

1. An infant combined foot reflexology and teething method which involves covering an infant's foot and toes with an article of clothing and a teether (“cap”), which jointly serve as a foot reflexology and teething device, and which are comprised of:
a) an article of fabric, which includes a single opening.
b) a “cap” teether attached to the article of clothing, across the outer surface of the article of clothing, without forming a second opening in the article of clothing.
c) a secured single opening, sometimes secured via velcro, used to secure the invention to the infant's foot.

2. The method of claim 1, wherein the article of clothing is one of a sock or bootie.
Obviously, numerous variations and modifications can be made without departing from the spirit of the present invention. Therefore, it should be clearly understood that the forms of the present invention described above, and shown in the FIGURE of the accompanying drawing, are illustrative only and are not intended to limit the scope of the present invention.
